(19) United States
(12) Patent Application Publication
(10) Pub. No.: US 2026/0219670 A1
(43) Pub. Date: Jul. 30, 2026

(54) Learning an Ego State Model Through Perceptual Boosting

(71) Applicant: GDM HOLDING LLC, Mountain View, CA (US)

(72) Inventors: Ammar Husain, San Francisco, CA (US); Korbinian Nico Schmid, Munich (DE)

(21) Appl. No.: 19/141,500

(22) PCT Filed: Dec. 18, 2023
(86) PCT No.: PCT/US2023/084626

§ 371 Date: Jun. 20, 2025

Related U.S. Application Data
(60) Provisional application No. 63/476,312, filed on Dec. 20, 2022.

(51) Int. Cl. G05D 1/246; G05D 1/243; G05D 111/10; G06V 20/70

(52) U.S. Cl. CPC G05D 1/2467; G05D 1/243; G06V 20/70; G05D 2111/17

(57) ABSTRACT

It is proposed a method for navigating a robotic device which includes the following steps: capturing (602), by at least one sensor on a robotic device, at least one image representative of an environment; determining (604), based on the at least one image of the environment, a segmentation map, where the segmentation map segments the at least one image into a plurality of pixel areas with corresponding semantic classifications, where the plurality of pixel areas includes at least one pixel area with a semantic classification of a ground surface in the environment; adjusting (606) an ego state estimation model running on the robotic device based on the semantic classification of the ground surface in the environment, where the ego state estimation model is configured to maintain a pose of the robotic device; and causing (608) the robotic device to navigate in the environment based on the adjusted ego state estimation model.

### CROSS-REFERENCE TO RELATED APPLICATIONS

This application claims priority to U.S. Provisional Patent Application No. 63/476,312, filed on Dec. 20, 2022, which is incorporated herein by reference in its entirety.

### BACKGROUND

As technology advances, various types of robotic devices are being created for performing a variety of functions that may assist users. Robotic devices may be used for applications involving material handling, transportation, welding, assembly, and dispensing, among others. Over time, the manner in which these robotic systems operate is becoming more intelligent, efficient, and intuitive. As robotic systems become increasingly prevalent in numerous aspects of modern life, it is desirable for robotic systems to be efficient. Therefore, a demand for efficient robotic systems has helped open up a field of innovation in actuators, movement, sensing techniques, as well as component design and assembly.

### SUMMARY

In an embodiment, a method includes capturing, by at least one sensor on a robotic device, at least one image representative of an environment. The method also includes determining, based on the at least one image of the environment, a segmentation map, wherein the segmentation map segments the at least one image into a plurality of pixel areas with corresponding semantic classifications, wherein the plurality of pixel areas includes at least one pixel area with a semantic classification of a ground surface in the environment. The method further includes adjusting an ego state estimation model running on the robotic device based on the semantic classification of the ground surface in the environment, wherein the ego state estimation model is configured to maintain a pose of the robotic device. The method additionally includes causing the robotic device to navigate in the environment based on the adjusted ego state estimation model.

In another embodiment, a system includes a processor and a non-transitory computer-readable medium having stored thereon instructions that, when executed by the processor, cause the processor to perform operations. The operations include capturing, by at least one sensor on a robotic device, at least one image representative of an environment. The operations further include determining, based on the at least one image of the environment, a segmentation map, wherein the segmentation map segments the at least one image into a plurality of pixel areas with corresponding semantic classifications, wherein the plurality of pixel areas includes at least one pixel area with a semantic classification of a ground surface in the environment. The operations additionally include adjusting an ego state estimation model running on the robotic device based on the semantic classification of the ground surface in the environment, wherein the ego state estimation model is configured to maintain a pose of the robotic device. The operations further include causing the robotic device to navigate in the environment based on the adjusted ego state estimation model.

In another embodiment, a robotic device includes at least one sensor and a control system. The control system is configured to capture, by at least one sensor on a robotic device, at least one image representative of an environment. The control system is also configured to determine, based on the at least one image of the environment, a segmentation map, where the segmentation map segments the at least one image into a plurality of pixel areas with corresponding semantic classifications, where the plurality of pixel areas includes at least one pixel area with a semantic classification of a ground surface in the environment. The control system is also configured to adjust an ego state estimation model running on the robotic device based on the semantic classification of the ground surface in the environment, where the ego state estimation model is configured to maintain a pose of the robotic device. The control system is also configured to cause the robotic device to navigate in the environment based on the adjusted ego state estimation model.

In a further embodiment, a system is provided that includes means for capturing, by at least one sensor on a robotic device, at least one image representative of an environment. The system also includes means for determining, based on the at least one image of the environment, a segmentation map, wherein the segmentation map segments the at least one image into a plurality of pixel areas with corresponding semantic classifications, wherein the plurality of pixel areas includes at least one pixel area with a semantic classification of a ground surface in the environment. The system further includes means for adjusting an ego state estimation model running on the robotic device based on the semantic classification of the ground surface in the environment, wherein the ego state estimation model is configured to maintain a pose of the robotic device. The system additionally includes means for causing the robotic device to navigate in the environment based on the adjusted ego state estimation model.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates a configuration of a robotic system, in accordance with example embodiments.

FIG. 2 illustrates a mobile robot, in accordance with example embodiments.

FIG. 3 illustrates an exploded view of a mobile robot, in accordance with example embodiments.

FIG. 4 illustrates a robotic arm, in accordance with example embodiments.

FIG. 5 is a diagram illustrating training and inference phases of a machine learning model, in accordance with example embodiments.

FIG. 6 is a block diagram of a method, in accordance with example embodiments.

FIG. 7 depicts an environment of a robot, in accordance with example embodiments.

FIG. 8 depicts images of an environment, in accordance with example embodiments.

FIG. 9 is a block diagram of an ego state estimation model, in accordance with example embodiments.

FIG. 10 depicts robotic devices operating on surfaces, in accordance with example embodiments.

FIG. 11 depicts an environment of a robot, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

A robotic device may navigate through environments with various types of ground surfaces. For example, in an office environment, the robotic device may navigate from a conference room with carpet to a guest area with wood flooring to a kitchenette with tile. Sensor data collected by the robotic device may vary in reliability depending on the type of ground surface on which that the robotic device is navigating. For example, data collected by the robotic device while navigating over carpet may include more noise, as carpet has noticeable texture. Whereas, data collected by the robotic device while navigating over wood flooring may include less noise, as wood flooring is relatively flat. Data collected by the robotic device while navigating over tile flooring may also include more noise as there may be grooves between each tile.

While navigating through the environment, the robotic device may encounter various obstacles, and the robotic device may unintentionally drive over the obstacles. It may be advantageous for the robotic device to avoid driving over obstacles, as driving over obstacles may cause issues with navigation. For example, the environment in which the robotic device is navigating may include a power cord on the ground, and the robotic device may fail to detect the power cord before driving over it. The robotic device may detect that it likely drove over an unmapped obstacle, and the robotic device may stop to analyze whether the obstacle was actually an obstacle and/or the consequences of driving over such an obstacle, thereby disrupting navigation of the robotic device.

Depending on the type of flooring in the environment in which the robotic device is driving, the robotic device may have difficulty distinguishing whether it actually drove over an obstacle. In particular, certain types of flooring may cause the robotic device to stop and analyze whether it drove over an obstacle due to the texture of the flooring. Although the robotic device may ultimately determine that it did not drive over an obstacle, navigation of the robotic device may nevertheless be disrupted. The start and stopping may cause delays in completion of tasks, particularly when the robotic device frequently stops in environments where the texture of the flooring is particularly noisy.

Provided herein are methods to improve navigation of the robotic device through determining and/or updating an ego state estimation model that serves as the basis through which sensor data is analyzed. The ego state of the robotic device may be a pose of the robotic device expressed in odometry frame. The ego state estimation model may further include various variables that may impact the states of the robotic device, including the velocity and acceleration of the robotic device, among other variables. In addition, the ego state estimation model may include states, which may maintain poses of the robotic device over time, uncertainties of the poses over time, and other variables over time that may affect navigation of the robotic device. States of the robotic device included by the ego state estimation model may include an ego state, a tracking state, an estimated state, an error state, and a real state, among others.

A computing device of the robotic device may store the ego state estimation model, and the computing device may be able to access the various states and variables of the ego state estimation model. The computing device may maintain the various states of the ego state estimation model over time, perhaps by updating the various states using recently collected sensor data. The ego state estimation model may facilitate navigation of the robotic device, such as facilitating determination of outliers in sensor data.

In some examples, to facilitate determining and/or updating the ego state estimation model, the robotic device may determine the type of ground surface on which the robotic device is navigating. The robotic device may use one or more sensors to collect data representative of the environment and the robotic device may analyze the data. In particular, the robotic device may use a machine learning model to segment captured images into a segmentation map that defines a plurality of pixel areas with corresponding semantic classifications. In some images, at least one of the pixel areas may have a semantic classification corresponding to a ground surface in the environment. In some examples, the robotic device may have access to a list of semantic classifications that correspond to ground surfaces, and the robotic device may compare each of the semantic classifications with the list. Additionally and/or alternatively, the robotic device may determine a ground surface based on the location and/or shape of the pixel area relative to the rest of the pixel areas.

In some examples, the robotic device may determine and/or update the ego state estimation model by way of a grip coefficient, which may be based on the ground surface type and the wheel type. Based on the grip coefficient, the robotic device may determine which sensor measurements, if any, are outliers and the robotic device may analyze the data without these sensor measurements.

The robotic device may then navigate in the environment based on the updated ego state estimation model. In particular, the robotic device may navigate based on data filtered using the ego state estimation model. For example, the robotic device may determine that it is navigating in an environment with carpet flooring and the robotic device may set the grip coefficient accordingly. The robotic device may collect additional data representative of the environment. Although this additional data may be noisy, the robotic device may filter the data based on the ego state estimation model, which may remove sources of potential noise in the collected data.

By filtering the data to remove the noise, the computing device may be able to more accurately differentiate between noise that the ground surface causes and obstacles in the environment. The robotic device being able to more accurately differentiate between noise that the ground surface causes and obstacles in the environment may help the robotic device navigate more smoothly and more accurately map obstacles in the environment.

### II. Example Robotic Systems

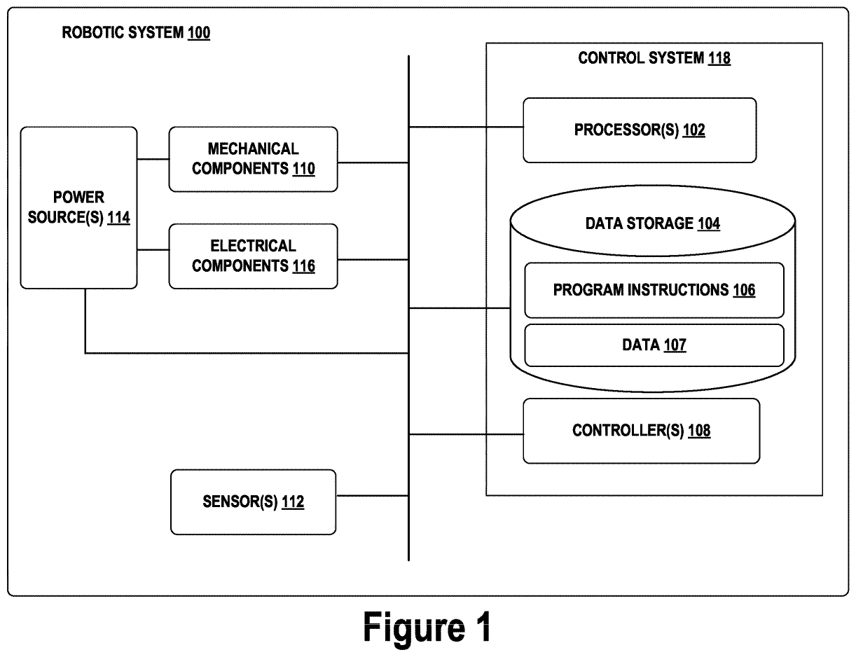

FIG. 1 illustrates an example configuration of a robotic system that may be used in connection with the implementations described herein. Robotic system 100 may be configured to operate autonomously, semi-autonomously, or using directions provided by user(s). Robotic system 100 may be implemented in various forms, such as a robotic arm, industrial robot, or some other arrangement. Some example implementations involve a robotic system 100 engineered to be low cost at scale and designed to support a variety of tasks. Robotic system 100 may be designed to be capable of operating around people. Robotic system 100 may also be optimized for machine learning. Throughout this description, robotic system 100 may also be referred to as a robot, robotic device, or mobile robot, among other designations.

As shown in FIG. 1, robotic system 100 may include processor(s) 102, data storage 104, and controller(s) 108, which together may be part of control system 118. Robotic system 100 may also include sensor(s) 112, power source(s) 114, mechanical components 110, and electrical components 116. Nonetheless, robotic system 100 is shown for illustrative purposes, and may include more or fewer components. The various components of robotic system 100 may be connected in any manner, including wired or wireless connections. Further, in some examples, components of robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). Processor(s) 102 may be configured to execute computer-readable program instructions 106, and manipulate data 107, both of which are stored in data storage 104. Processor(s) 102 may also directly or indirectly interact with other components of robotic system 100, such as sensor(s) 112, power source(s) 114, mechanical components 110, or electrical components 116.

Data storage 104 may be one or more types of hardware memory. For example, data storage 104 may include or take the form of one or more computer-readable storage media that can be read or accessed by processor(s) 102. The one or more computer-readable storage media can include volatile or non-volatile storage components, such as optical, magnetic, organic, or another type of memory or storage, which can be integrated in whole or in part with processor(s) 102. In some implementations, data storage 104 can be a single physical device. In other implementations, data storage 104 can be implemented using two or more physical devices, which may communicate with one another via wired or wireless communication. As noted previously, data storage 104 may include the computer-readable program instructions 106 and data 107. Data 107 may be any type of data, such as configuration data, sensor data, or diagnostic data, among other possibilities.

Controller 108 may include one or more electrical circuits, units of digital logic, computer chips, or microprocessors that are configured to (perhaps among other tasks), interface between any combination of mechanical components 110, sensor(s) 112, power source(s) 114, electrical components 116, control system 118, or a user of robotic system 100. In some implementations, controller 108 may be a purpose-built embedded device for performing specific operations with one or more subsystems of the robotic system 100.

Control system 118 may monitor and physically change the operating conditions of robotic system 100. In doing so, control system 118 may serve as a link between portions of robotic system 100, such as between mechanical components 110 or electrical components 116. In some instances, control system 118 may serve as an interface between robotic system 100 and another computing device. Further, control system 118 may serve as an interface between robotic system 100 and a user. In some instances, control system 118 may include various components for communicating with robotic system 100, including a joystick, buttons, or ports, etc. The example interfaces and communications noted above may be implemented via a wired or wireless connection, or both. Control system 118 may perform other operations for robotic system 100 as well.

During operation, control system 118 may communicate with other systems of robotic system 100 via wired or wireless connections, and may further be configured to communicate with one or more users of the robot. As one possible illustration, control system 118 may receive an input (e.g., from a user or from another robot) indicating an instruction to perform a requested task, such as to pick up and move an object from one location to another location. Based on this input, control system 118 may perform operations to cause the robotic system 100 to make a sequence of movements to perform the requested task. As another illustration, a control system may receive an input indicating an instruction to move to a requested location. In response, control system 118 (perhaps with the assistance of other components or systems) may determine a direction and speed to move robotic system 100 through an environment en route to the requested location.

Operations of control system 118 may be carried out by processor(s) 102. Alternatively, these operations may be carried out by controller(s) 108, or a combination of processor(s) 102 and controller(s) 108. In some implementations, control system 118 may partially or wholly reside on a device other than robotic system 100, and therefore may at least in part control robotic system 100 remotely.

Mechanical components 110 represent hardware of robotic system 100 that may enable robotic system 100 to perform physical operations. As a few examples, robotic system 100 may include one or more physical members, such as an arm, an end effector, a head, a neck, a torso, a base, and wheels. The physical members or other parts of robotic system 100 may further include actuators arranged to move the physical members in relation to one another. Robotic system 100 may also include one or more structured bodies for housing control system 118 or other components, and may further include other types of mechanical components. The particular mechanical components 110 used in a given robot may vary based on the design of the robot, and may also be based on the operations or tasks the robot may be configured to perform.

In some examples, mechanical components 110 may include one or more removable components. Robotic system 100 may be configured to add or remove such removable components, which may involve assistance from a user or another robot. For example, robotic system 100 may be configured with removable end effectors or digits that can be replaced or changed as needed or desired. In some implementations, robotic system 100 may include one or more removable or replaceable battery units, control systems, power systems, bumpers, or sensors. Other types of removable components may be included within some implementations.

Robotic system 100 may include sensor(s) 112 arranged to sense aspects of robotic system 100. Sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, or cameras, among other possibilities. Within some examples, robotic system 100 may be configured to receive sensor data from sensors that are physically separated from the robot (e.g., sensors that are positioned on other robots or located within the environment in which the robot is operating).

Sensor(s) 112 may provide sensor data to processor(s) 102 (perhaps by way of data 107) to allow for interaction of robotic system 100 with its environment, as well as monitoring of the operation of robotic system 100. The sensor data may be used in evaluation of various factors for activation, movement, and deactivation of mechanical components 110 and electrical components 116 by control system 118. For example, sensor(s) 112 may capture data corresponding to the terrain of the environment or location of nearby objects, which may assist with environment recognition and navigation.

In some examples, sensor(s) 112 may include RADAR (e.g., for long-range object detection, distance determination, or speed determination), LIDAR (e.g., for short-range object detection, distance determination, or speed determination), SONAR (e.g., for underwater object detection, distance determination, or speed determination), VICON® (e.g., for motion capture), one or more cameras (e.g., stereoscopic cameras for 3D vision), a global positioning system (GPS) transceiver, or other sensors for capturing information of the environment in which robotic system 100 is operating. Sensor(s) 112 may monitor the environment in real time, and detect obstacles, elements of the terrain, weather conditions, temperature, or other aspects of the environment. In another example, sensor(s) 112 may capture data corresponding to one or more characteristics of a target or identified object, such as a size, shape, profile, structure, or orientation of the object.

Further, robotic system 100 may include sensor(s) 112 configured to receive information indicative of the state of robotic system 100, including sensor(s) 112 that may monitor the state of the various components of robotic system 100. Sensor(s) 112 may measure activity of systems of robotic system 100 and receive information based on the operation of the various features of robotic system 100, such as the operation of an extendable arm, an end effector, or other mechanical or electrical features of robotic system 100. The data provided by sensor(s) 112 may enable control system 118 to determine errors in operation as well as monitor overall operation of components of robotic system 100.

As an example, robotic system 100 may use force/torque sensors to measure load on various components of robotic system 100. In some implementations, robotic system 100 may include one or more force/torque sensors on an arm or end effector to measure the load on the actuators that move one or more members of the arm or end effector. In some examples, the robotic system 100 may include a force/torque sensor at or near the wrist or end effector, but not at or near other joints of a robotic arm. In further examples, robotic system 100 may use one or more position sensors to sense the position of the actuators of the robotic system. For instance, such position sensors may sense states of extension, retraction, positioning, or rotation of the actuators on an arm or end effector.

As another example, sensor(s) 112 may include one or more velocity or acceleration sensors. For instance, sensor(s) 112 may include an inertial measurement unit (IMU). The IMU may sense velocity and acceleration in the world frame, with respect to the gravity vector. The velocity and acceleration sensed by the IMU may then be translated to that of robotic system 100 based on the location of the IMU in robotic system 100 and the kinematics of robotic system 100.

Robotic system 100 may include other types of sensors not explicitly discussed herein. Additionally or alternatively, the robotic system may use particular sensors for purposes not enumerated herein.

Robotic system 100 may also include one or more power source(s) 114 configured to supply power to various components of robotic system 100. Among other possible power systems, robotic system 100 may include a hydraulic system, electrical system, batteries, or other types of power systems. As an example illustration, robotic system 100 may include one or more batteries configured to provide charge to components of robotic system 100. Some of mechanical components 110 or electrical components 116 may each connect to a different power source, may be powered by the same power source, or be powered by multiple power sources.

Any type of power source may be used to power robotic system 100, such as electrical power or a gasoline engine. Additionally or alternatively, robotic system 100 may include a hydraulic system configured to provide power to mechanical components 110 using fluid power. Components of robotic system 100 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of robotic system 100. Power source(s) 114 may charge using various types of charging, such as wired connections to an outside power source, wireless charging, combustion, or other examples.

Electrical components 116 may include various mechanisms capable of processing, transferring, or providing electrical charge or electric signals. Among possible examples, electrical components 116 may include electrical wires, circuitry, or wireless communication transmitters and receivers to enable operations of robotic system 100. Electrical components 116 may interwork with mechanical components 110 to enable robotic system 100 to perform various operations. Electrical components 116 may be configured to provide power from power source(s) 114 to the various mechanical components 110, for example. Further, robotic system 100 may include electric motors. Other examples of electrical components 116 may exist as well.

Robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to operate in tight spaces may have a relatively tall, narrow body. Further, the body or the other components may be developed using various types of materials, such as metals or plastics. Within other examples, a robot may have a body with a different structure or made of various types of materials.

The body or the other components may include or carry sensor(s) 112. These sensors may be positioned in various locations on the robotic system 100, such as on a body, a head, a neck, a base, a torso, an arm, or an end effector, among other examples.

Robotic system 100 may be configured to carry a load, such as a type of cargo that is to be transported. In some examples, the load may be placed by the robotic system 100 into a bin or other container attached to the robotic system 100. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, robotic system 100 may include various types of appendages, wheels, end effectors, gripping devices and so on. In some examples, robotic system 100 may include a mobile base with wheels, treads, or some other form of locomotion. Additionally, robotic system 100 may include a robotic arm or some other form of robotic manipulator. In the case of a mobile base, the base may be considered as one of mechanical components 110 and may include wheels, powered by one or more of actuators, which allow for mobility of a robotic arm in addition to the rest of the body.

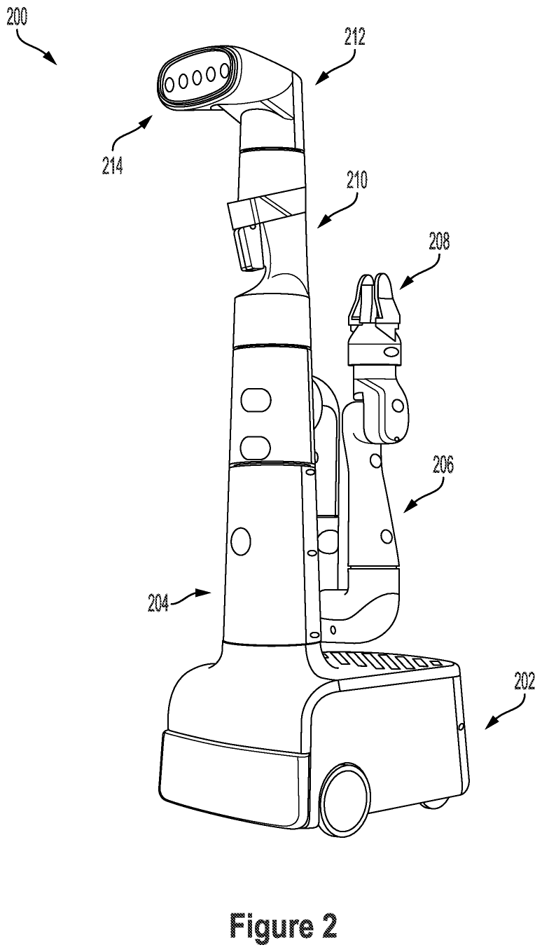

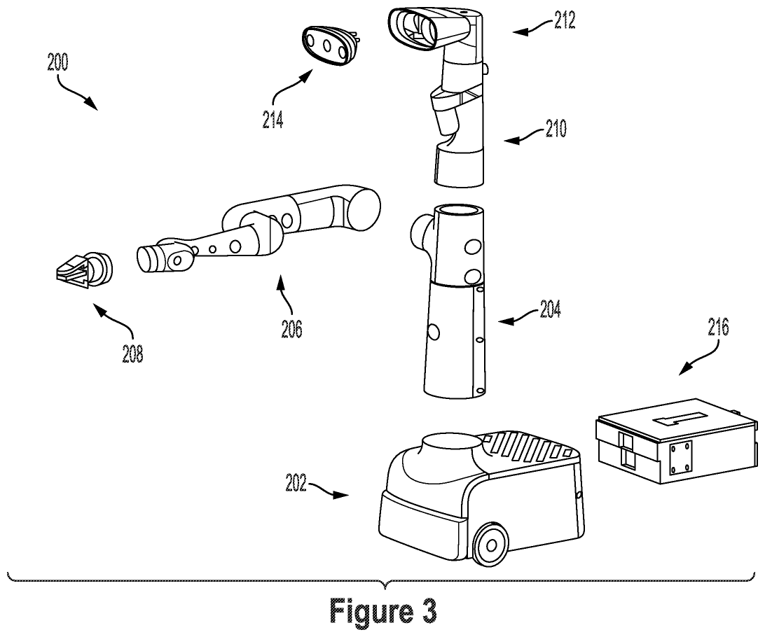

FIG. 2 illustrates a mobile robot, in accordance with example embodiments. FIG. 3 illustrates an exploded view of the mobile robot, in accordance with example embodiments. More specifically, a robot 200 may include a mobile base 202, a midsection 204, an arm 206, an end-of-arm system (EOAS) 208, a mast 210, a perception housing 212, and a perception suite 214. The robot 200 may also include a compute box 216 stored within mobile base 202.

The mobile base 202 includes two drive wheels positioned at a front end of the robot 200 in order to provide locomotion to robot 200. The mobile base 202 also includes additional casters (not shown) to facilitate motion of the mobile base 202 over a ground surface. The mobile base 202 may have a modular architecture that allows compute box 216 to be easily removed. Compute box 216 may serve as a removable control system for robot 200 (rather than a mechanically integrated control system). After removing external shells, the compute box 216 can be easily removed and/or replaced. The mobile base 202 may also be designed to allow for additional modularity. For example, the mobile base 202 may also be designed so that a power system, a battery, and/or external bumpers can all be easily removed and/or replaced.

The midsection 204 may be attached to the mobile base 202 at a front end of the mobile base 202. The midsection 204 includes a mounting column which is fixed to the mobile base 202. The midsection 204 additionally includes a rotational joint for arm 206. More specifically, the midsection 204 includes the first two degrees of freedom for arm 206 (a shoulder yaw J0 joint and a shoulder pitch J1 joint). The mounting column and the shoulder yaw J0 joint may form a portion of a stacked tower at the front of mobile base 202. The mounting column and the shoulder yaw J0 joint may be coaxial. The length of the mounting column of midsection 204 may be chosen to provide the arm 206 with sufficient height to perform manipulation tasks at commonly encountered height levels (e.g., coffee table top and counter top levels). The length of the mounting column of midsection 204 may also allow the shoulder pitch J1 joint to rotate the arm 206 over the mobile base 202 without contacting the mobile base 202.

The arm 206 may be a 7DOF robotic arm when connected to the midsection 204. As noted, the first two DOFs of the arm 206 may be included in the midsection 204. The remaining five DOFs may be included in a standalone section of the arm 206 as illustrated in FIGS. 2 and 3. The arm 206 may be made up of plastic monolithic link structures. Inside the arm 206 may be housed standalone actuator modules, local motor drivers, and thru bore cabling.

The EOAS 208 may be an end effector at the end of arm 206. EOAS 208 may allow the robot 200 to manipulate objects in the environment. As shown in FIGS. 2 and 3, EOAS 208 may be a gripper, such as an underactuated pinch gripper. The gripper may include one or more contact sensors such as force/torque sensors and/or non-contact sensors such as one or more cameras to facilitate object detection and gripper control. EOAS 208 may also be a different type of gripper such as a suction gripper or a different type of tool such as a drill or a brush. EOAS 208 may also be swappable or include swappable components such as gripper digits.

The mast 210 may be a relatively long, narrow component between the shoulder yaw J0 joint for arm 206 and perception housing 212. The mast 210 may be part of the stacked tower at the front of mobile base 202. The mast 210 may be fixed relative to the mobile base 202. The mast 210 may be coaxial with the midsection 204. The length of the mast 210 may facilitate perception by perception suite 214 of objects being manipulated by EOAS 208. The mast 210 may have a length such that when the shoulder pitch J1 joint is rotated vertical up, a topmost point of a bicep of the arm 206 is approximately aligned with a top of the mast 210. The length of the mast 210 may then be sufficient to prevent a collision between the perception housing 212 and the arm 206 when the shoulder pitch J1 joint is rotated vertical up.

As shown in FIGS. 2 and 3, the mast 210 may include a 3D lidar sensor configured to collect depth information about the environment. The 3D lidar sensor may be coupled to a carved-out portion of the mast 210 and fixed at a downward angle. The lidar position may be optimized for localization, navigation, and for front cliff detection.

The perception housing 212 may include at least one sensor making up perception suite 214. The perception housing 212 may be connected to a pan/tilt control to allow for reorienting of the perception housing 212 (e.g., to view objects being manipulated by EOAS 208). The perception housing 212 may be a part of the stacked tower fixed to the mobile base 202. A rear portion of the perception housing 212 may be coaxial with the mast 210.

The perception suite 214 may include a suite of sensors configured to collect sensor data representative of the environment of the robot 200. The perception suite 214 may include an infrared (IR)-assisted stereo depth sensor. The perception suite 214 may additionally include a wide-angled red-green-blue (RGB) camera for human-robot interaction and context information. The perception suite 214 may additionally include a high resolution RGB camera for object classification. A face light ring surrounding the perception suite 214 may also be included for improved human-robot interaction and scene illumination. In some examples, the perception suite 214 may also include a projector configured to project images and/or video into the environment.

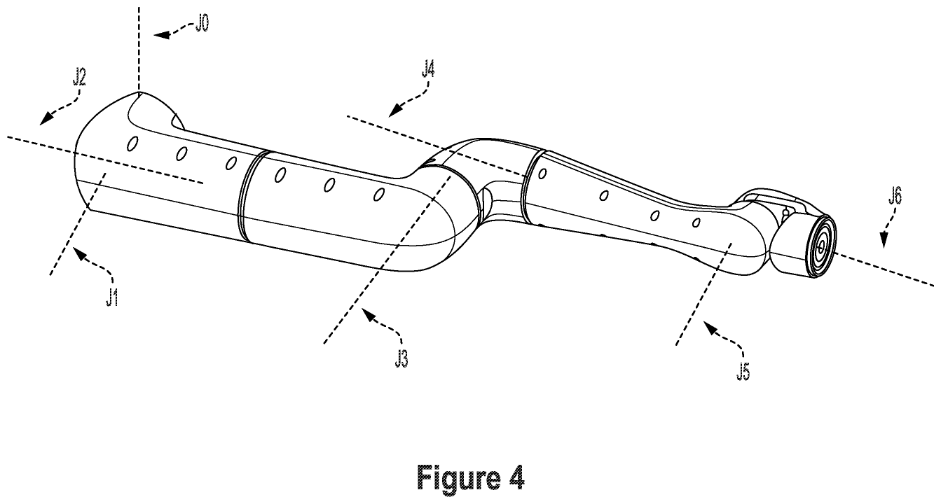

FIG. 4 illustrates a robotic arm, in accordance with example embodiments. The robotic arm includes 7 DOFs: a shoulder yaw J0 joint, a shoulder pitch J1 joint, a bicep roll J2 joint, an elbow pitch J3 joint, a forearm roll J4 joint, a wrist pitch J5 joint, and wrist roll J6 joint. Each of the joints may be coupled to one or more actuators. The actuators coupled to the joints may be operable to cause movement of links down the kinematic chain (as well as any end effector attached to the robot arm).

The shoulder yaw J0 joint allows the robot arm to rotate toward the front and toward the back of the robot. One beneficial use of this motion is to allow the robot to pick up an object in front of the robot and quickly place the object on the rear section of the robot (as well as the reverse motion). Another beneficial use of this motion is to quickly move the robot arm from a stowed configuration behind the robot to an active position in front of the robot (as well as the reverse motion).

The shoulder pitch J1 joint allows the robot to lift the robot arm (e.g., so that the bicep is up to perception suite level on the robot) and to lower the robot arm (e.g., so that the bicep is just above the mobile base). This motion is beneficial to allow the robot to efficiently perform manipulation operations (e.g., top grasps and side grasps) at different target height levels in the environment. For instance, the shoulder pitch J1 joint may be rotated to a vertical up position to allow the robot to easily manipulate objects on a table in the environment. The shoulder pitch J1 joint may be rotated to a vertical down position to allow the robot to easily manipulate objects on a ground surface in the environment.

The bicep roll J2 joint allows the robot to rotate the bicep to move the elbow and forearm relative to the bicep. This motion may be particularly beneficial for facilitating a clear view of the EOAS by the robot's perception suite. By rotating the bicep roll J2 joint, the robot may kick out the elbow and forearm to improve line of sight to an object held in a gripper of the robot.

Moving down the kinematic chain, alternating pitch and roll joints (a shoulder pitch J1 joint, a bicep roll J2 joint, an elbow pitch J3 joint, a forearm roll J4 joint, a wrist pitch J5 joint, and wrist roll J6 joint) are provided to improve the manipulability of the robotic arm. The axes of the wrist pitch J5 joint, the wrist roll J6 joint, and the forearm roll J4 joint are intersecting for reduced arm motion to reorient objects. The wrist roll J6 point is provided instead of two pitch joints in the wrist in order to improve object rotation.

In some examples, a robotic arm such as the one illustrated in FIG. 4 may be capable of operating in a teach mode. In particular, teach mode may be an operating mode of the robotic arm that allows a user to physically interact with and guide robotic arm towards carrying out and recording various movements. In a teaching mode, an external force is applied (e.g., by the user) to the robotic arm based on a teaching input that is intended to teach the robot regarding how to carry out a specific task. The robotic arm may thus obtain data regarding how to carry out the specific task based on instructions and guidance from the user. Such data may relate to a plurality of configurations of mechanical components, joint position data, velocity data, acceleration data, torque data, force data, and power data, among other possibilities.

During teach mode the user may grasp onto the EOAS or wrist in some examples or onto any part of robotic arm in other examples, and provide an external force by physically moving robotic arm. In particular, the user may guide the robotic arm towards grasping onto an object and then moving the object from a first location to a second location. As the user guides the robotic arm during teach mode, the robot may obtain and record data related to the movement such that the robotic arm may be configured to independently carry out the task at a future time during independent operation (e.g., when the robotic arm operates independently outside of teach mode). In some examples, external forces may also be applied by other entities in the physical workspace such as by other objects, machines, or robotic systems, among other possibilities.

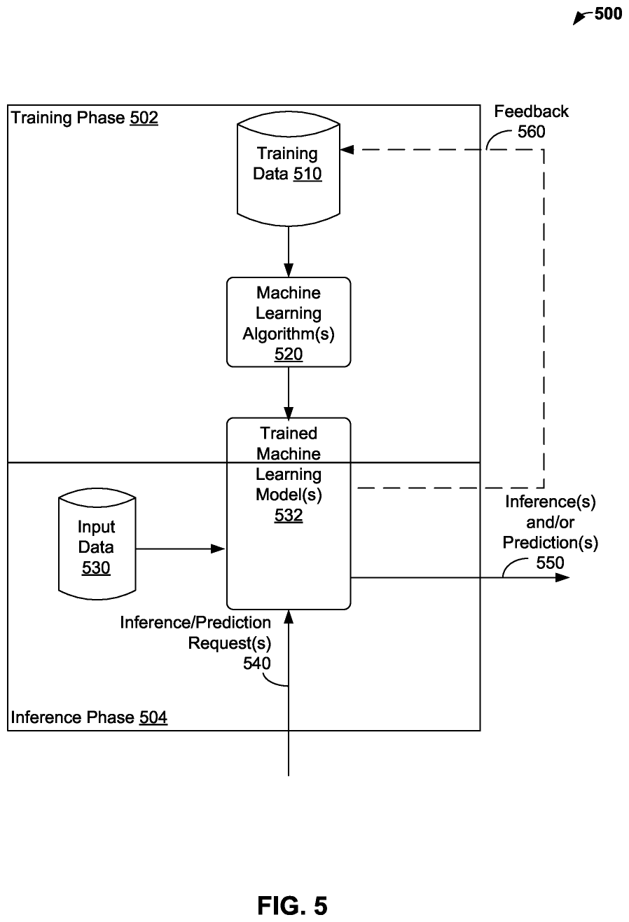

FIG. 5 shows diagram 500 illustrating a training phase 502 and an inference phase 504 of trained machine learning model(s) 532, in accordance with example embodiments. Some machine learning techniques involve training one or more machine learning algorithms, on an input set of training data to recognize patterns in the training data and provide output inferences and/or predictions about (patterns in the) training data. The resulting trained machine learning algorithm can be referred to as a trained machine learning model. For example, FIG. 5 shows training phase 502 where one or more machine learning algorithms 520 are being trained on training data 510 to become trained machine learning model(s) 532. Then, during inference phase 504, trained machine learning model(s) 532 can receive input data 530 and one or more inference/prediction requests 540 (perhaps as part of input data 530) and responsively provide as an output one or more inferences and/or prediction(s) 550.

As such, trained machine learning model(s) 532 can include one or more models of one or more machine learning algorithms 520. Machine learning algorithm(s) 520 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 520 may be supervised or unsupervised, and may implement any suitable combination of online and offline learning.

In some examples, machine learning algorithm(s) 520 and/or trained machine learning model(s) 532 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 520 and/or trained machine learning model(s) 532. In some examples, trained machine learning model(s) 532 can be trained, reside and execute to provide inferences on a particular computing device, and/or otherwise can make inferences for the particular computing device.

During training phase 502, machine learning algorithm(s) 520 can be trained by providing at least training data 510 as training input using unsupervised, supervised, semi-supervised, and/or reinforcement learning techniques. Unsupervised learning involves providing a portion (or all) of training data 510 to machine learning algorithm(s) 520 and machine learning algorithm(s) 520 determining one or more output inferences based on the provided portion (or all) of training data 510. Supervised learning involves providing a portion of training data 510 to machine learning algorithm(s) 520, with machine learning algorithm(s) 520 determining one or more output inferences based on the provided portion of training data 510, and the machine learning model may be refined based on correct results associated with training data 510. In some examples, supervised learning of machine learning algorithm(s) 520 can be governed by a set of rules and/or a set of labels for the training input, and the set of rules and/or set of labels may be used to correct inferences of machine learning algorithm(s) 520.

Semi-supervised learning involves having correct results for part, but not all, of training data 510. During semi-supervised learning, supervised learning is used for a portion of training data 510 having correct results, and unsupervised learning is used for a portion of training data 510 not having correct results. Reinforcement learning involves machine learning algorithm(s) 520 receiving a reward signal regarding a prior inference, where the reward signal can be a numerical value. During reinforcement learning, machine learning algorithm(s) 520 can output an inference and receive a reward signal in response, where machine learning algorithm(s) 520 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 520 and/or trained machine learning model(s) 532 can be trained using other machine learning techniques, including but not limited to, incremental learning and curriculum learning.

In some examples, machine learning algorithm(s) 520 and/or trained machine learning model(s) 532 can use transfer learning techniques. For example, transfer learning techniques can involve trained machine learning model(s) 532 being pre-trained on one set of data and additionally trained using training data 510. More particularly, machine learning algorithm(s) 520 can be pre-trained on data from one or more computing devices and a resulting trained machine learning model provided to computing device CD1, where CD1 is intended to execute the trained machine learning model during inference phase 504. Then, during training phase 502, the pre-trained machine learning model can be additionally trained using training data 510, where training data 510 can be derived from kernel and non-kernel data of computing device CD1. This further training of the machine learning algorithm(s) 520 and/or the pre-trained machine learning model using training data 510 of CD1's data can be performed using either supervised or unsupervised learning. Once machine learning algorithm(s) 520 and/or the pre-trained machine learning model has been trained on at least training data 510, training phase 502 can be completed. The trained resulting machine learning model can be utilized as at least one of trained machine learning model(s) 532.

In particular, once training phase 502 has been completed, trained machine learning model(s) 532 can be provided to a computing device, if not already on the computing device. Inference phase 504 can begin after trained machine learning model(s) 532 are provided to computing device CD1.

During inference phase 504, trained machine learning model(s) 532 can receive input data 530 and generate and output one or more corresponding inferences and/or prediction(s) 550 about input data 530. As such, input data 530 can be used as an input to trained machine learning model(s) 532 for providing corresponding inference(s) and/or prediction(s) 550 to kernel components and non-kernel components. For example, trained machine learning model(s) 532 can generate inference(s) and/or prediction(s) 550 in response to one or more inference/prediction requests 540. In some examples, trained machine learning model(s) 532 can be executed by a portion of other software. For example, trained machine learning model(s) 532 can be executed by an inference or prediction daemon to be readily available to provide inferences and/or predictions upon request. Input data 530 can include data from computing device CD1 executing trained machine learning model(s) 532 and/or input data from one or more computing devices other than CD1.

Input data 530 can include training data described herein. Other types of input data are possible as well.

Inference(s) and/or prediction(s) 550 can include task outputs, numerical values, and/or other output data produced by trained machine learning model(s) 532 operating on input data 530 (and training data 510). In some examples, trained machine learning model(s) 532 can use output inference(s) and/or prediction(s) 550 as input feedback 560. Trained machine learning model(s) 532 can also rely on past inferences as inputs for generating new inferences.

After training, the trained version of the neural network can be an example of trained machine learning model(s) 532. In this approach, an example of the one or more inference/prediction request(s) 540 can be a request to predict a classification for an input training example and a corresponding example of inferences and/or prediction(s) 550 can be a predicted classification output.

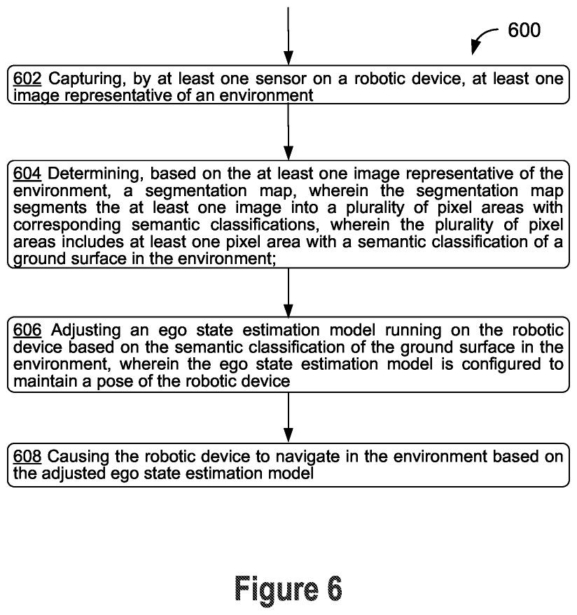

FIG. 6 is a block diagram of a method, in accordance with example embodiments. Blocks 602, 604, 606, and 608 may collectively be referred to as method 600. In some examples, method 600 of FIG. 6 may be carried out by a control system, such as control system 118 of robotic system 100. In further examples, method 600 of FIG. 6 may be carried out by a computing device or a server device remote from the robotic device. In still further examples, method 600 may be carried out by one or more processors, such as processor(s) 102, executing program instructions, such as program instructions 106, stored in a data storage, such as data storage 104. Execution of method 600 may involve a robotic device, such as the robotic device illustrated and described with respect to FIGS. 1-4. Further, execution of method 600 may involve a computing device or a server device remote from the robotic device and robotic system 100. Other robotic devices may also be used in the performance of method 600. In further examples, some or all of the blocks of method 600 may be performed by a control system remote from the robotic device. In yet further examples, different blocks of method 600 may be performed by different control systems, located on and/or remote from a robotic device.

Those skilled in the art will understand that the block diagram of FIG. 6 illustrates functionality and operation of certain implementations of the present disclosure. In this regard, each block of the block diagram may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 602, method 600 includes capturing, by at least one sensor on a robotic device, at least one image representative of an environment. A robotic device may include a camera, LIDAR sensor, or other sensor which may be used to generate an image representative of the environment.

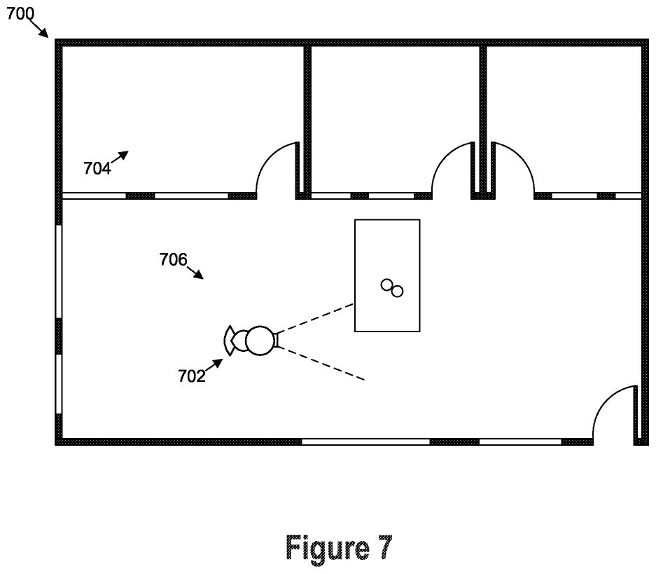

FIG. 7 depicts environment 700, in accordance with example embodiments. Environment 700 may include room 704 and room 706. Robotic device 702 may also be located in environment 700. As illustrated in FIG. 7, robotic device 702 may be located in room 706. Robotic device 702 may navigate between rooms and/or environments. For example, robotic device 702 may navigate from room 706 to room 704.

In some examples, room 704, room 706, and other rooms in the environment may have ground materials of various types. For example, room 704 may include wood flooring, whereas room 706 may include carpet flooring. Other ground materials types are also possible (e.g., concrete). When the robotic device navigates from one area with one type of ground material to another type of ground material, the robotic device may have difficulty with determining whether collected sensor data is accurate. In particular, certain types of ground materials may have different textures, which may cause the data collected by the robotic device to vary. For example, data collected by the robotic device navigating on a carpeted surface of an environment may include more noise due to the texture of the carpet and the interaction between the carpet and the wheels of the robotic device. In contrast, data collected by the robotic device navigating on a wood floor may include less noise due to the smooth texture of a wood floor and the interaction between the wood floor and the wheels of the robotic device.

Referring back to FIG. 6, at block 604, method 600 includes determining, based on the at least one image of the environment, a segmentation map, where the segmentation map segments the at least one image into a plurality of pixel areas with corresponding semantic classifications, where the plurality of pixel areas includes at least one pixel area with a semantic classification of a ground surface in the environment.

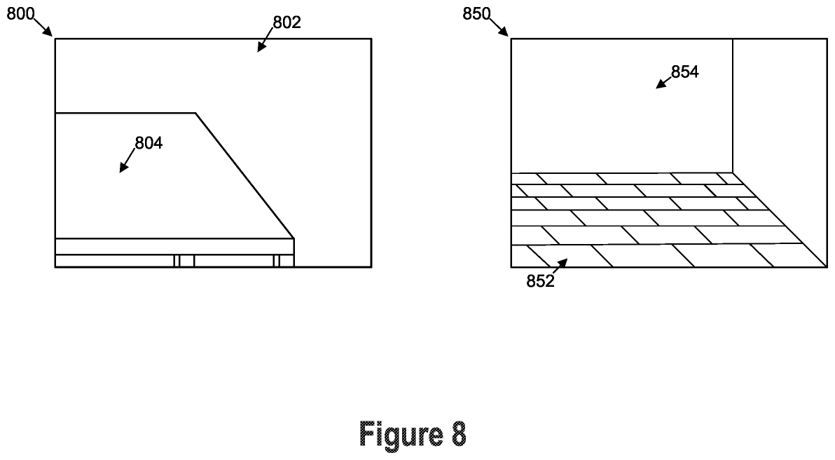

FIG. 8 depicts images 800 and 850 of an environment, in accordance with example embodiments. A robotic device, perhaps robotic device 702 operating in environment 700, may capture images 800 and 850 of the environment, which the robotic device may then segment into a plurality of pixel areas with corresponding pixel classifications.

For example, the robotic device may capture image 800 of the environment and segment image 800 into a plurality of pixel areas, perhaps including a pixel area for carpet 802 and a pixel area for table 804. At another location in the environment, the robotic device may capture image 850 of the environment and segment image 850 into a plurality of pixel areas, including a pixel area for wood floor 852 and a pixel area for wall 854. In some examples, the computing device may apply a machine learning model to the image (e.g., image 800 and/or image 850) to determine a segmentation map of the images into a plurality of pixel areas with corresponding semantic classifications.

The robotic device may then determine which of the segmented areas corresponds to the ground surface of the environment. In some examples, the robotic device may have access to a list of semantic classifications that could correspond with a ground surface of the environment. Additionally and/or alternatively, the robotic device may determine where the ground surface is likely to be in an environment (e.g., near the bottom edge of an image) and determine the semantic classification that corresponds to that area in the image.

At block 606, method 600 includes adjusting an ego state estimation model running on the robotic device based on the semantic classification of the ground surface in the environment, where the ego state estimation model is configured to maintain a pose of the robotic device.

Based on the semantic classification of the ground surface, the robotic device may determine a grip coefficient. The grip coefficient may correspond with the semantic classification of the ground surface and a type of wheel of the robotic device. Conceptually, the grip coefficient may represent certainty and/or uncertainty in the environment and how well the wheels grip the ground surface. Additionally and/or alternatively, the robotic device may include one or more components of a particular type and the grip coefficients may be associated with one or more of these components. In some examples, the one or more components may cause the robotic device to navigate in the environment (e.g., wheels and/or an extremity).

In some examples, the robotic device may store a mapping between a plurality of ground surface semantic classifications and one or more grip coefficients. The mapping may also include one or more wheel types, such that a ground surface semantic classification and a grip coefficient corresponds to a particular grip coefficient. The robotic device may then determine the grip coefficient by accessing the mapping to match the determined ground surface semantic classification with the ground surface semantic classification in the mapping and perhaps the wheel type of the robotic device with a wheel type in the mapping.

Based on the grip coefficient, the robotic device may adjust the ego state estimation model. For instance, the ego state estimation model may include a measure for the grip coefficient, and the robotic device may update the ego state estimation model with the determined grip coefficient. Additionally and/or alternatively, the ego state estimation model may include a robotic device velocity and a velocity uncertainty measure. The robotic device may update each of these measures based on the grip coefficient. For example, if the robotic device has a wheel type with a larger diameter and the robotic device determines the ground surface to be wood, then the robotic device may determine a corresponding grip coefficient. Based on the corresponding grip coefficient, the robotic device may determine a greater robotic device velocity and that the velocity uncertainty measure also increases by an additional factor.

The ego state estimation model may include a variety of other variables, and the robotic device may also adjust one or more of the other variables based on the grip coefficient and/or ego state estimation model. In particular, the ego state estimation model may have real-time estimation of 6-dimensional poses and velocities for the base and head, estimation of uncertainties, and high bandwidth state estimation to be usable for control. The robotic device may update the ego state estimation model based on sensor data at a sampling rate of 250 Hz or greater. In addition, the ego state estimation model may have parameters that are not sensitive to the environment, reject samples that are outliers, account for robotic device slippage, among other properties.

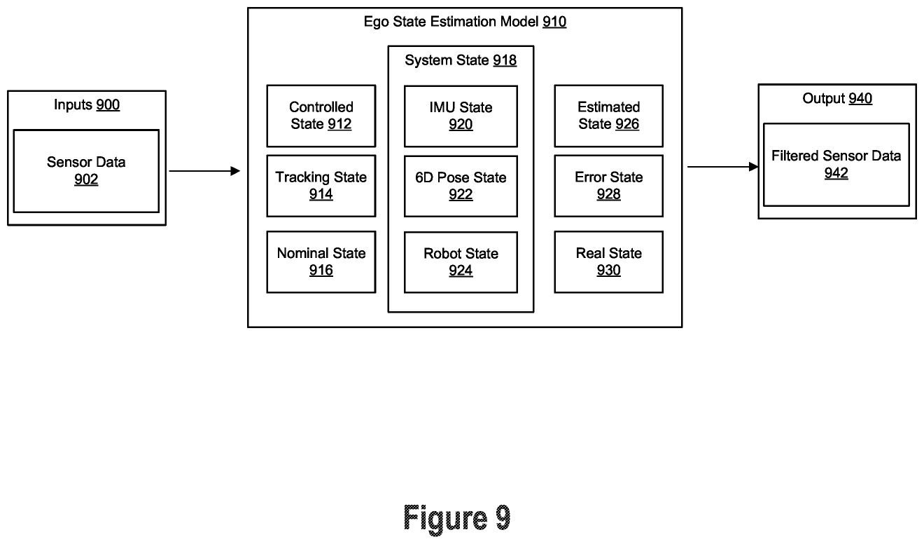

FIG. 9 is a block diagram of ego state estimation model 910, in accordance with example embodiments. The robotic device (or a computing device of the robotic device) may use ego state estimation model 910 to determine outputs 940, including filtered sensor data 942. The robotic device may determine outputs 940 based on inputs 900, such as sensor data 902. As mentioned, the states and/or outputs of ego state estimation model 910 may depend on a grip coefficient.

Ego state estimation model 910 includes controlled state 912, tracking state 914, nominal state 916, system state 918, estimated state 926, error state 928, and real state 930. System state 918 may include IMU state 920, 6D pose state 922, and robot state 924. Ego state estimation model 910 may include information on how system state 918 and its uncertainty evolves over time. In addition, ego state estimation model 910 may include coefficients that model a continuous system model using linearized and discretized propagation equations. 6D pose state 922 may be referred to herein as a “pose” of the robotic device.

As mentioned, system state 918 may be partitioned into IMU state 920, 6D pose state 922, and robot state 924. In particular, system state 918 may include vectors representing the IMU position

$$( {t}_{LB}^{L} ) ,$$

IMU velocity

$$( {v}_{LB}^{L} ) ,$$

IMU orientation

$$( {}_{}^{L} {q}_{B}^{} ) ,$$

accelerator bias

$$( {b}_{a}^{B} ) ,$$

gyroscope bias

$$( {b}_{ω}^{B} ) ,$$

pseudo gravity (g̅^{L}), IMU position

$$( {t}_{LB , k}^{L} ) ,$$

IMU orientation

$$( {}_{}^{L} {q}_{B , k}^{} ) ,$$

ground contact point of left wheel

$$( {t}_{{BW}_{L}}^{B} ) ,$$

ground contact point of right wheel

$$( {t}_{{BW}_{R}}^{B} ) ,$$

robot orientation (^{R}q_{B}), left wheel radius (rₗ), and right wheel radius (rᵣ). The IMU state may be the state of an IMU sensor in the robotic device, and each of the vectors associated with the IMU position, IMU velocity, IMU orientation, and IMU orientation may be determined based on data collected using the IMU. The IMU may include one or more sensors, including one or more gyroscopes and one or more accelerometers.

The standard kinematic equations with random walk processes for biases may be used for the continuous propagation model of the IMU state:

$${\dot{t}}_{LB}^{L} = {v}_{LB}^{L} , {\dot{v}}_{LB}^{L} = {a}_{LB}^{L} , {}_{}^{L} {\dot{q}}_{B}^{} = {}_{}^{L} {q}_{B}^{} ⊗ Exp ( {ω}_{LB}^{B} )$$

$${\dot{b}}_{a}^{B} = {n}_{a} , {\dot{b}}_{ω}^{B} = {n}_{ω}$$

$${\dot{\overline{g}}}_{BR}^{L} = 0 ,$$

Rotations may be parameterized in tangent space of the quaternion unit sphere and an error state space representation may thus be chosen for all states. The IMU state, the error state, and the corresponding noise vector may thus be defined as:

$${𝕩}_{IMU} = [ \begin{matrix}{t}_{LB}^{L} \\ {v}_{LB}^{L} \\ {}_{}^{L} {q}_{B}^{} \\ {b}_{a}^{B} \\ {b}_{ω}^{B} \\ {\overline{g}}^{L}\end{matrix} ] ∈ ℝ , δ {x}_{IMU} = [ \begin{matrix}δ t \\ δ v \\ δ θ \\ δ \text{?} \\ δ \text{?} \\ δ \overline{g}\end{matrix} ] ∈ {ℝ}^{18} , n = [ \begin{matrix}\text{?} \\ \text{?} \\ \text{?} \\ \text{?}\end{matrix} ] ∈ {ℝ}^{12}$$

$$\text{?} \text{indicates text missing or illegible when filed}$$

Euler integration may be used to calculate the system state propagation from time k to k+1X with a sampling time of Δt:

$${\hat{t}}_{LB , k + 1}^{L} = {\hat{t}}_{LB , k}^{L} + {\hat{v}}_{LB , k}^{L} Δ t + \frac{1}{2} ( {}_{}^{L} {\hat{R}}_{B , k}^{} ( {\tilde{a}}_{k}^{B} - \text{?} ) + {\hat{\overline{g}}}_{k}^{L} ) Δ {t}^{2}$$

$${\hat{v}}_{LB , k + 1}^{L} = {\hat{v}}_{LB , k}^{L} + ( {}_{}^{L} {\hat{R}}_{B , k}^{} ( {\tilde{a}}_{k}^{B} - \text{?} ) + {\hat{\overline{g}}}_{k}^{L} ) Δ t$$

$${}_{}^{L} {\hat{q}}_{B , k + 1}^{} = {}_{}^{L} {\hat{q}}_{B , k}^{} ⊗ Exp ( ( \tilde{ω} - \text{?} ) Δ t )$$

$$\text{?} = \text{?} , \text{?} = \text{?} , {\hat{\overline{g}}}_{k + 1}^{L} = {\hat{\overline{g}}}_{k}^{L}$$

$$\text{?} \text{indicates text missing or illegible when filed}$$

The standard definition for the relation between real state, estimated state, and error state may be used for vectors and rotations below, respectively:

$$x = \hat{x} + δ x$$

$${}_{}^{L} {R}_{B}^{} = Exp ( ⌊ δ θ ⌋ ) {}_{}^{L} {\hat{R}}_{B}^{} \approx ( I + ⌊ δ θ ⌋ ) {}_{}^{L} {\hat{R}}_{B}^{}$$

$${}_{}^{L} {q}_{B}^{} = δ q ⊗ {}_{}^{L} {\hat{q}}_{B}^{} = Exp ( δ θ ) ⊗ {}_{}^{L} {\hat{q}}_{B}^{} \approx ( \begin{matrix}1 \\ \frac{1}{2} δ θ\end{matrix} ) ⊗ {}_{}^{L} {\hat{q}}_{B}^{}$$

The orientation error is expressed in the local reference frame.

Ego state estimation model 910 may also include a 6D clone state that stays constant while the robotic device is still. It may be replaced every propagation step by current 6D pose state 922 when the robotic device is moving. The clone state may be used for measurement in integration: in driving mode, rotational rates may be used in the measurement equation and a correlation may be introduced between the system and the measurement model. The orientation clone is used to model this correlation. The clone state partition may be defined as:

$$\text{?} = [ \begin{matrix}{\hat{t}}_{LB , k}^{L} \\ {}_{}^{L} {\hat{q}}_{B , k}^{}\end{matrix} ] δ \text{?} = [ \begin{matrix}δ {t}_{k} \\ δ {θ}_{k}\end{matrix} ]$$

$$\text{?} \text{indicates text missing or illegible when filed}$$

The third partition of the state vector may hold the robot state and its corresponding error:

$${\hat{x}}_{robot} = [ \begin{matrix}\text{?} \\ \text{?} \\ \text{?} \\ \text{?} \\ \text{?}\end{matrix} ] , δ {x}_{robot} = [ \begin{matrix}\text{?} \\ \text{?} \\ \text{?} \\ \text{?} \\ \text{?}\end{matrix} ]$$

$$\text{?} \text{indicates text missing or illegible when filed}$$

The robot state may be assumed to be constant.

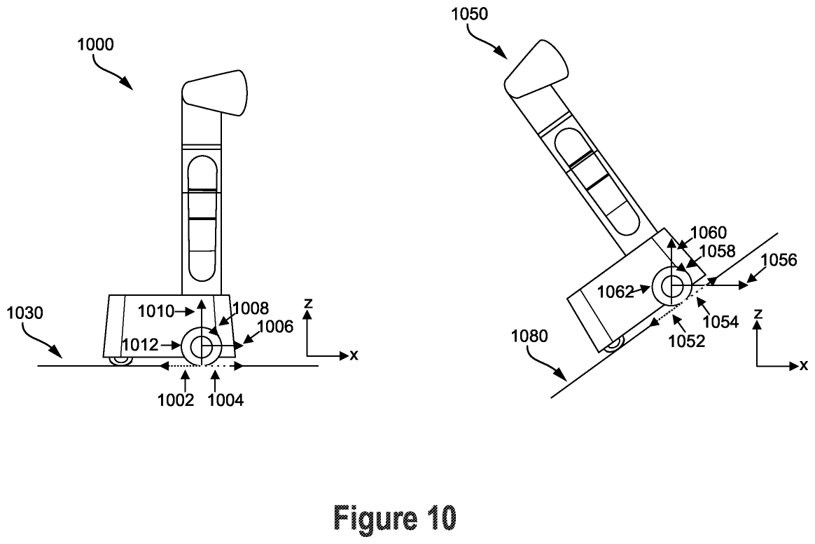

Measurement calculations for ego state estimation model 910 may be affected by a grip coefficient, which may depend on the type of surface on which the robotic device is operating. FIG. 10 depicts robotic device 1000 operating on surface 1030 and on surface 1080, in accordance with example embodiments. Robotic device 1000 operating on surface 1030 may be the best case, whereas robotic device 1050 operating on surface 1080 may be the worst case, where the robotic device is parallel to the ground plane and has a maximum z-induced velocity. Robotic devices 1000 and 1050 may determine a classification for surface 1030 and a classification for surface 1080 respectively based on images and/or other sensor data that the robotic device captures, as described above.

As shown in FIG. 10, robotic device 1000 includes wheel 1012, for which various properties and/or measures may be determined. Also illustrated in FIG. 10 is arrow 1002 (which may represent the turning speed at contact point), arrow 1004 (which may represent the induced speed), arrow 1006 (which may represent the x-axis), arrow 1008 (which may represent the rotational velocity, w), and arrow 1010 (which may represent the z-axis). The robotic device may determine turning speed at contact point arrow 1002, induced speed arrow 1004, and rotational velocity arrow 1008. Robotic device 1000 may also determine additional values, including, for example, the linear velocity of the robotic device.

In the worst case, robotic device 1050 may be operating on ground surface 1080 and may include wheel 1062. Robotic device 1050 may calculate various values for the ego state estimation, including, for example, turning speed at contact point (indicated by arrow 1052), induced speed (indicated by arrow 1054), and rotational velocity, w (as indicated by arrow 1058). Also illustrated in FIG. 10 are z-axis arrow 1060 and x-axis arrow 1056.

Ground surface 1080 may be slanted such that robotic device 1050 may slip or be unable to grip ground surface 1080, which may depend on which type of material is used for ground surface 1080. For example, if wood flooring is used for ground surface 1080, then robotic device 1050 may be less prone to slippage whereas if carpet is used for ground surface 1080, then robotic device 1050 may be more prone to slippage. Robotic device 1000 and robotic 1050 may take this slippage factor into account when determining sensor data.

In particular, the robotic device may collect sensor data and identify samples that are outliers using Mahalanobis gating based on the ego state estimation model. In some examples, the robotic device may assume that the slip factor only appears in the direction of induced velocity, which is predominately on the x-axis (e.g., as indicated by x-axis arrow 1006 of robotic device 1000 operating on ground surface 1030 and as indicated by x-axis arrow 1056 of robotic device 1050 operating on ground surface 1080). The robotic device may determine y and z velocities, which may represent damping the velocity drift of the IMU model. With the assumption that the measurement for y is always correct, a conservative measurement for z may be determined. Consequently, the measurements for y-axes and z-axes may be used without determining and/or rejecting outliers, and the robotic device may only determine and/or reject outliers for measurements occurring in the x-axis. The robotic device may have access to one or more equations to determine outliers with the assumptions outlined above. The robotic device may exclude the outliers from the adjusted data upon which the robotic device bases navigation.

Based on the equations to determine outliers, the robotic device may fuse sensor data obtained using various sensors. In some examples, the robotic device may use an extended Kalman filter for sensor data fusion, such that the equations used for determining outliers are used for error state covariance propagation and the calculation of errors during an update step. The robotic device may correct the nominal state of the ego state estimation model after each update step and reset the error. This iterative process may improve estimation quality and may be applied depending on the timing constraints.

Additionally and/or alternatively, the robotic device may use the ego state estimation model to alter a bias or otherwise recalibrate the sensors of the robotic device. For example, the robotic device may include an inertial measurement unit and the robotic device may alter the bias of the inertial measurement unit to have a constant offset from a value that is collected. In particular, the inertial measurement unit may include a gyroscope and/or an accelerometer, and the robotic device may alter the bias of one or more of these sensors such that the output adjusted data is more likely to be accurate.

In some examples, the robotic device may determine the segmentation map at a first frequency and the robotic device may update the ego state segmentation model at a second frequency that is greater than the first frequency. For example, the robotic device may have a period of time when it is not navigating in the environment. The robotic device may update the ego state estimation model, perhaps for other components on the robotic device, but the robotic device may not determine another segmentation map. Further, because some of the measurements in the ego state estimation model may depend on the grip coefficient and other parameters, the measurements in the ego state estimation model may be updated as the other parameters change while using the same grip coefficient, thereby allowing for smooth navigation without having to continuously determine a segmentation map.

Referring back to FIG. 6, at block 608, method 600 includes causing the robotic device to navigate in the environment based on the adjusted ego state estimation model. As mentioned, the ego state estimation model may facilitate filtering data such that outliers are removed. The robotic device may thus navigate based on the filtered data and ignore the outliers when determining where in the environment to navigate.

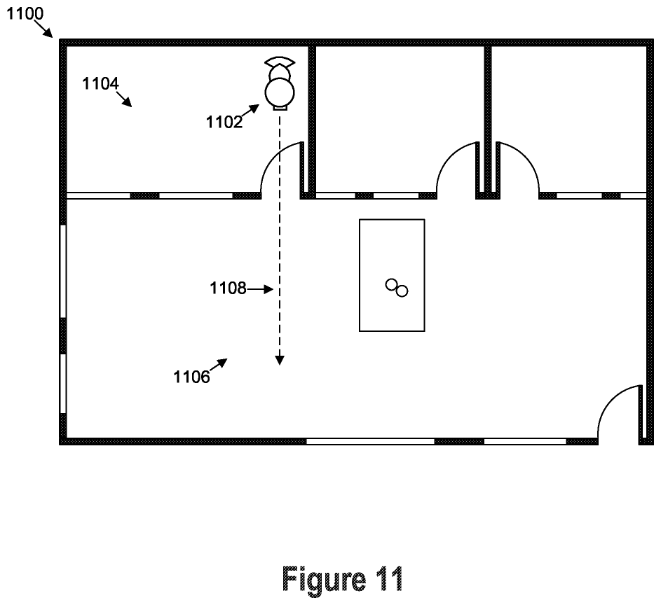

FIG. 11 depicts robotic device 1102 in environment 1100, in accordance with example embodiments. Environment 1100 may include room 1104 and room 1106. Room 1104 may have a different ground surface material compared to room 1106. For example, room 1104 may have wood flooring as the ground material, whereas room 1106 may have carpet flooring as the ground material. Robotic device 1102 may be located in room 1104 and may take path 1108 to room 1106.

When robotic device 1102 navigates from room 1104 to room 1106, the ground surface may change, which may impact the sensor measurements that are collected. For example, robotic device 1102 may collect sensor measurements with less noise when it is in room 1104 with wood flooring, whereas, robotic device 1102 may collect sensor measurements with more noise when it is in room 1106 with carpet flooring. Further, during the transition from room 1104 to room 1106, there may be a transition piece that causes the robotic device to jolt upwards and downwards.

Robotic device 1102 may continuously collect sensor data as it navigates from room to room and robotic device 1102 may periodically update the ego state estimation model based on the sensor data. For example, when robotic device 1102 is in room 1104, robotic device 1102 may identify the ground surface as wood flooring and update the ego state estimation model to reflect that the ground surface is wood flooring (e.g., the ego state estimation model may filter out less measurements as outliers and may be associated with higher certainties). When robotic device 1102 approaches the intersection of room 1104 and room 1106, robotic device 1102 may identify that it is nearing an area where the ground surface type changes from wood to carpet. Robotic device 1102 may then update the ego state estimation model to reflect that the ground surface will change within a particular distance, and that the ego state estimation model may filter out less measurements as outliers and may be associated with lower certainties. Therefore, when robotic device 1102 drives over the intersection of room 1104 and room 1106, robotic device 1102 may determine that the jolt is not abnormal and that the data being collected is not certain. After robotic device 1102 navigates to room 1104, robotic device 1102 may determine that room 1104 has carpet flooring, and robotic device 1102 may update the ego state estimation model to filter out more measurements as outliers and that it is associated with more uncertainties. Thus, when robotic device 1102 navigates to room 1106, robotic device 1102 may filter out more sensor measurements as outliers and have more uncertainty about whether the measurements are accurate.

Without using and/or updating the ego state estimation, robotic device 1102 may have difficulty navigating smoothly. For example, robotic device 1102 may drive over the transition from room 1104 and room 1106 and stop to determine whether driving over the transition between those two rooms was a mistake. Additionally and/or alternatively, when robotic device 1102 may switch from driving from wood flooring to carpet flooring, robotic device 1102 may incorrectly consider measurements that are likely outliers as indicative of driving over objects in the ground, and robotic device 1102 may navigate away from the carpeted area, when in reality, the robotic device 1102 is merely driving on a different surface.

Referring back to FIG. 6, in some examples, method 600 may also include based on the semantic classification of the ground surface in the environment, determining a grip coefficient, wherein the ego state estimation model is adjusted based on the grip coefficient.

In some examples, the robotic device comprises one or more wheels of a particular wheel type, wherein the grip coefficient is determined based on the particular wheel type.

In some examples, the robotic device stores a mapping between one or more ground surface semantic classifications and one or more grip coefficients, where the one or more ground surface semantic classifications comprises the semantic classification of the ground surface in the environment, where determining the grip coefficient is based on the mapping.

In some examples, adjusting the ego state estimation model comprises determining a robotic device velocity and a velocity uncertainty measure based on the grip coefficient, where the ego state estimation model is further configured to include the robotic device velocity and the velocity uncertainty measure.

In some examples, the at least one sensor is a plurality of sensors, where method 600 further comprises determining sensor data based on fusing the sensor data from each sensor in the plurality of sensors and determining one or more obstacles in the environment based on the sensor data and the ego state estimation model.

In some examples, the at least one sensor is a plurality of sensors, where method 600 further comprises determining sensor data based on fusing the sensor data from each sensor in the plurality of sensors and determining a location of the robotic device in the environment based on the sensor data and the ego state estimation model.

In some examples, method 600 further comprises receiving data from an additional sensor on the robotic device and verifying the data based on the adjusted ego state estimation model.

In some examples, causing the robotic device to navigate in the environment based on the adjusted ego state estimation model comprises receiving data from at least one additional sensor on the robotic device and determining adjusted data based on the ego state estimation model and the data.

In some examples, the at least one additional sensor comprises an inertial measurement unit, wherein determining the adjusted data comprises altering a bias of the inertial measurement unit based on the ego state estimation model.

In some examples, the inertial measurement unit comprises a gyroscope, wherein altering a bias of the inertial measurement unit based on the ego state estimation model comprises altering a bias of the gyroscope based on the ego state estimation model.

In some examples, the inertial measurement unit comprises an accelerometer, where altering a bias of the inertial measurement unit based on the ego state estimation model comprises altering a bias of the accelerometer based on the ego state estimation model.

In some examples, the semantic classification of the ground surface in the environment is a carpet, a concrete surface, or a wood surface.

In some examples, determining the segmentation map occurs periodically at a first frequency, where adjusting the ego state estimation model occurs periodically at a second frequency, wherein the first frequency is less than the second frequency.

In some examples, the at least one pixel area with the semantic classification of the ground surface in the environment comprises a first pixel area with a first semantic classification of the ground surface in the environment and a second pixel area with a second semantic classification of the ground surface in the environment, where adjusting the ego state estimation model is based on the first and the second semantic classifications.

In some examples, the ego state estimation model comprises a state of the robotic device relative to an odometry frame.

In some examples, the ego state estimation model is further configured to include a linear velocity of the robotic device and a rotational velocity of the robotic device.

In some examples, method 600 may be carried out by a robotic device including at least one sensor and a control system configured to perform the operations of method 600.

In some examples, the robotic device carrying out method 600 further comprises one or more components of a particular type that cause the robotic device to navigate in the environment, where adjusting the ego state estimation model is also based on the particular type of the one or more components.

In some examples, the one or more components that cause the robotic device to navigate in the environment comprise a wheel or an extremity.

In some examples, method 600 may be carried out by a non-transitory computer readable medium comprising program instructions executable by at least one processor to cause the at least one processor to perform the operations of method 600.

### III. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
capturing, by at least one sensor on a robotic device, at least one image representative of an environment;
determining, based on the at least one image representative of the environment, a segmentation map, wherein the segmentation map segments the at least one image into a plurality of pixel areas with corresponding semantic classifications, wherein the plurality of pixel areas includes at least one pixel area with a semantic classification of a ground surface in the environment;
adjusting an ego state estimation model running on the robotic device based on the semantic classification of the ground surface in the environment, wherein the ego state estimation model is configured to maintain a pose of the robotic device; and
causing the robotic device to navigate in the environment based on the adjusted ego state estimation model.

2. The method of claim 1, further comprising:
based on the semantic classification of the ground surface in the environment, determining a grip coefficient, wherein the ego state estimation model is adjusted based on the grip coefficient.

3. The method of claim 2, wherein the robotic device comprises one or more wheels of a particular wheel type, wherein the grip coefficient is determined based on the particular wheel type.

4. The method of claim 2, wherein the robotic device stores a plurality of ground surface semantic classifications and one or more grip coefficients, wherein the one or more ground surface semantic classifications comprises the semantic classification of the ground surface in the environment, wherein determining the grip coefficient is based on the mapping.

5. The method of claim 2, wherein adjusting the ego state estimation model comprises determining a robotic device velocity and a velocity uncertainty measure based on the grip coefficient, wherein the ego state estimation model is further configured to include the robotic device velocity and the velocity uncertainty measure.

6. The method of claim 1, wherein the at least one sensor is a plurality of sensors, wherein the method further comprises:
determining sensor data based on fusing the sensor data from each sensor in the plurality of sensors; and
determining one or more obstacles in the environment based on the sensor data and the ego state estimation model.

7. The method of claim 1, wherein the at least one sensor is a plurality of sensors, wherein the method further comprises:
determining sensor data based on fusing the sensor data from each sensor in the plurality of sensors; and
determining a location of the robotic device in the environment based on the sensor data and the ego state estimation model.

8. The method of claim 1, wherein the method further comprises:
receiving data from an additional sensor on the robotic device; and
verifying the data based on the adjusted ego state estimation model.

9. The method of claim 1, wherein causing the robotic device to navigate in the environment based on the adjusted ego state estimation model comprises:
receiving data from at least one additional sensor on the robotic device; and
determining adjusted data based on the ego state estimation model and the data.

10. The method of claim 9, wherein the at least one additional sensor comprises an inertial measurement unit, wherein determining the adjusted data comprises altering a bias of the inertial measurement unit based on the ego state estimation model.

11. The method of claim 10, wherein the inertial measurement unit comprises a gyroscope, wherein altering a bias of the inertial measurement unit based on the ego state estimation model comprises altering a bias of the gyroscope based on the ego state estimation model.

12. The method of claim 10, wherein the inertial measurement unit comprises an accelerometer, wherein altering a bias of the inertial measurement unit based on the ego state estimation model comprises altering a bias of the accelerometer based on the ego state estimation model.

13. The method of claim 1, wherein the semantic classification of the ground surface in the environment is a carpet, a concrete surface, or a wood surface.

14. The method of claim 1, wherein determining the segmentation map occurs periodically at a first frequency, wherein adjusting the ego state estimation model occurs periodically at a second frequency, wherein the first frequency is less than the second frequency.

15. The method of claim 1, wherein the at least one pixel area with the semantic classification of the ground surface in the environment comprises a first pixel area with a first semantic classification of the ground surface in the environment and a second pixel area with a second semantic classification of the ground surface in the environment, wherein adjusting the ego state estimation model is based on the first and the second semantic classifications.

16. The method of claim 1, wherein the ego state estimation model comprises a state of the robotic device relative to an odometry frame.

17. The method of claim 1, wherein the ego state estimation model is further configured to include a linear velocity of the robotic device and a rotational velocity of the robotic device.

18. A robotic device comprising:
at least one sensor;
a control system configured to:
capture, by the at least one sensor on the robotic device, at least one image representative of an environment;
determine, based on the at least one image representative of the environment, a segmentation map, wherein the segmentation map segments the at least one image into a plurality of pixel areas with corresponding semantic classifications, wherein the plurality of pixel areas includes at least one pixel area with a semantic classification of a ground surface in the environment;
adjust an ego state estimation model running on the robotic device based on the semantic classification of the ground surface in the environment, wherein the ego state estimation model is configured to maintain a pose of the robotic device; and
cause the robotic device to navigate in the environment based on the adjusted ego state estimation model.

19. The robotic device of claim 18, wherein the robotic device further comprises one or more components of a particular type that cause the robotic device to navigate in the environment, wherein adjusting the ego state estimation model is also based on the particular type of the one or more components.

20. The robotic device of claim 19, wherein the one or more components that cause the robotic device to navigate in the environment comprise a wheel or an extremity.

21. A non-transitory computer readable medium comprising program instructions executable by at least one processor to cause the at least one processor to perform functions comprising:
capturing, by at least one sensor on a robotic device, at least one image representative of an environment;
determining, based on the at least one image representative of the environment, a segmentation map, wherein the segmentation map segments the at least one image into a plurality of pixel areas with corresponding semantic classifications, wherein the plurality of pixel areas includes at least one pixel area with a semantic classification of a ground surface in the environment;
adjusting an ego state estimation model running on the robotic device based on the semantic classification of the ground surface in the environment, wherein the ego state estimation model is configured to maintain a pose of the robotic device; and
causing the robotic device to navigate in the environment based on the adjusted ego state estimation model.

22. The method of claim 1, wherein adjusting the ego state estimation model running on the robotic device based on the semantic classification of the ground surface in the environment comprises adjusting one or more parameters of the ego state estimation model based on the semantic classification of the ground surface.
